(19) United States
(12) Patent Application Publication
(10) Pub. No.: US 2026/0244849 A1
(43) Pub. Date: Aug. 20, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Kohshiro Inomata, Kanagawa (JP)

(73) Assignee: FUJIFILM Business Innovation Corp., Tokyo (JP)

(21) Appl. No.: 19/313,079

(22) Filed: Aug. 28, 2025

(30) Foreign Application Priority Data
Feb. 19, 2025 (JP) 2025-024859

(51) Int. Cl. G06F 40/174; G06F 40/40; G06N 3/0475

(52) U.S. Cl. CPC G06F 40/174; G06F 40/40; G06N 3/0475

(57) ABSTRACT

An information processing system includes a processor configured to: acquire, by inputting form data to a language model, an entry area to be filled in by a user in the form data input to the language model from the language model, the form data being blank form data having no entry in the entry area; and specify the entry area in the form data input to the language model.

### CROSS-REFERENCE TO RELATED APPLICATIONS

This application is based on and claims priority under 35 USC 119 from Japanese Patent Application No. 2025-024859 filed Feb. 19, 2025.

### BACKGROUND

### (i) Technical Field

The present disclosure relates to an information processing system and a non-transitory computer readable medium.

### (ii) Related Art

Japanese Unexamined Patent Application Publication No. 2020-038736 discloses an information identifying program executed by a computer configuring an information identifying apparatus. The information identifying program causes the computer to execute: a first acquisition step of acquiring read-data indicating an image acquired by reading a written form which is a form in which characters including handwritten characters are written; a second acquisition step of acquiring form image data indicating an image of a form in which handwritten characters are not written, the form corresponding to the written form based on the read-data; a first area specifying step of specifying a first area enclosed by a contour corresponding to a first pixel value in the read-data; a third acquisition step of acquiring first area data indicating an image of the first area from the read-data; a form first area specifying step of specifying a form first area corresponding to the first area in the form image data; a fourth acquisition step of acquiring form first data indicating an image of the form first area from the form image data; a first determining step of determining whether the first area data and the form first data are different; and a first execution step of acquiring character string data indicating a character string including at least a first character string included in the first area based on character recognition processing when it is determined that the first area data and the form first data are different, and not acquiring the character string data when it is determined that the first area data and the form first data are not different.

Japanese Unexamined Patent Application Publication No. 2015-005100 discloses an information processing apparatus including a character identifying section configured to identify, from image information of a plurality of forms, fixed characters contained in advance in the forms and written characters written by a user; an area identifying section configured to identify, based on the fixed characters and the written characters identified by the character identifying section, a writing area in which a user can write characters in the forms and a non-writing area in which the user cannot write characters in the forms; and a generating section configured to generate a template of the forms based on the writing area and the non-writing area identified by the area identifying section.

### SUMMARY

There is a method of converting a form into electronic data and specifying an entry area to be filled in by a user. With the method of the related art, however, it is necessary to register in advance information related to the form used for specifying the entry area. In an unknown form, therefore, the entry area cannot be specified.

Aspects of non-limiting embodiments of the present disclosure relate to an information processing system and a non-transitory computer readable medium that are capable of specifying an entry area to be filled in by a user from a form, even when the form is an unknown form that is not registered in advance.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: acquire, by inputting form data to a language model, an entry area to be filled in by a user in the form data input to the language model from the language model, the form data being blank form data having no entry in the entry area; and specify the entry area in the form data input to the language model.

### BRIEF DESCRIPTION OF THE DRAWINGS

Exemplary embodiments of the present disclosure will be described in detail based on the following figures, wherein:

FIG. 1 is a diagram illustrating an example of a functional configuration of an information processing system;

FIG. 2 is a diagram illustrating an example of a form;

FIG. 3 is a diagram illustrating an entry example generated by a generative AI;

FIG. 4 is a diagram illustrating an example of processed data;

FIG. 5 is a diagram illustrating an example of a completed form filled out based on the entry example;

FIG. 6 is a diagram illustrating an example of a configuration of main parts of an electrical system of the information processing system;

FIG. 7 is a flowchart illustrating an example of a flow of output processing of the entry example;

FIG. 8 is a flowchart illustrating an example of a flow of entry area specifying processing;

FIG. 9 is a diagram illustrating an example of a completed form in which the entry example is replaced with user information; and

FIG. 10 is a diagram illustrating a display example of the completed form for which a correction instruction is accepted.

### DETAILED DESCRIPTION

Hereinafter, a present exemplary embodiment will be described with reference to the drawings. Note that the same components and the same processing are denoted by the same reference numerals throughout the drawings, and a repetitive description thereof will be omitted. The dimensional ratios in the drawings are exaggerated for convenience of description and may be different from actual ratios.

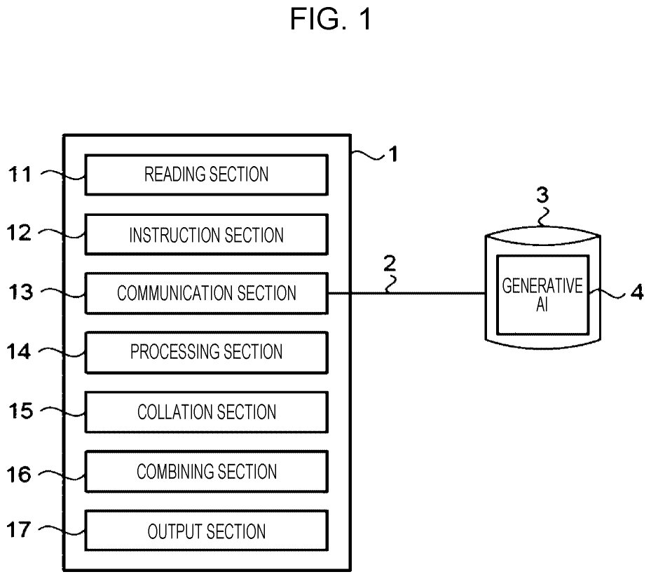

FIG. 1 is a diagram illustrating an example of a functional configuration of an information processing system 1. The information processing system 1 reads electronic data of a blank form 5 in which a user has not yet written any information, and specifies an entry area to be filled in by the user in the read electronic data of the form.

The information processing system 1 that performs such processing includes functional sections, namely, a reading section 11, an instruction section 12, a communication section 13, a processing section 14, a collation section 15, a combining section 16, and an output section 17.

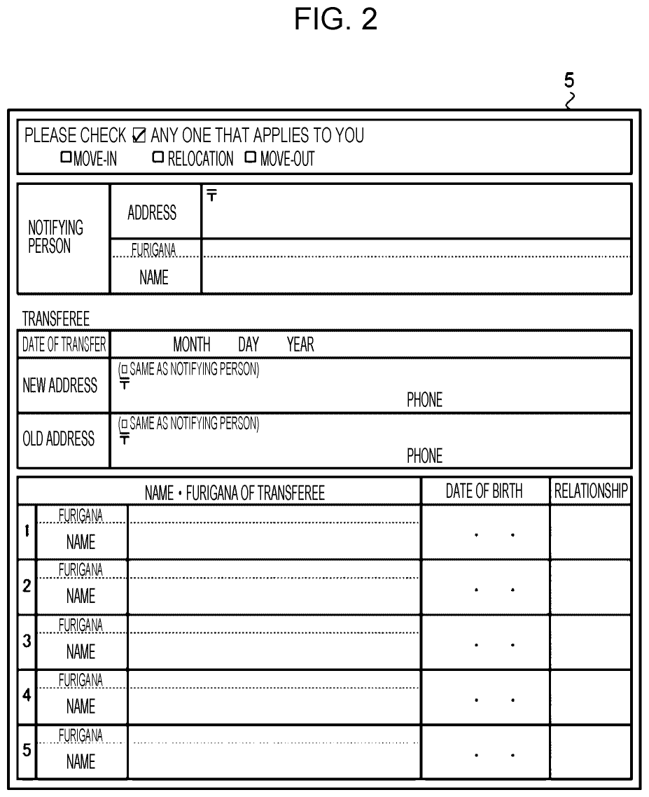

The reading section 11 reads electronic data of the form 5. FIG. 2 is a diagram illustrating an example of the form 5 represented by the electronic data read by the reading section 11. As illustrated in FIG. 2, the form 5 is in a blank state in which no information has yet been written by the user, and an entry format is determined in advance. Item names of items to be filled in by the user are contained in advance in the form 5. For example, in the form 5 illustrated in FIG. 2, “notifying person”, “name”, and the like represent the item names of the items to be filled in by the user. The items in the form 5 are provided with respective entry areas for entering contents. The entry areas are represented by, for example, areas each enclosed by a ruled line, symbols such as parentheses and a postal mark, and check fields to be filled or checked.

While the form 5 illustrated in FIG. 2 is a notification of address change that notifies a public office of a change of an address, a type of the form 5 to be read by the reading section 11 is not limited.

Hereinafter, the electronic data of the form 5 is referred to as “form data”. A document represented by the form data is the form 5. The form data includes character string data representing the item names and graphic data representing the ruled lines, the symbols, and the check fields, together with display position information of each data in the form 5.

The instruction section 12 illustrated in FIG. 1 instructs a generative artificial intelligence (AI) 4 to generate an entry example 6 of the form 5.

The generative AI 4 is a large language model built with a large amount of data and deep learning technology. The generative AI 4 may be a language model obtained by performing machine learning in advance using a large number of pieces of learning data in which the entry areas filled in by users are associated with form data representing layouts of various types of completed forms. Specifically, the entry areas filled in by users in the learning data are each represented by a character string representing an item name of the entry area filled in by a user and an entry content in the entry area. Suppose that a generation instruction to generate the entry example 6 of the form 5 and blank form data having no entry in the entry areas are input to the generative AI 4. In this case, the generative AI 4 outputs, as the entry area to be filled in by the user, a combination of the item name to be filled in by the user and the character string in the entry area, for the input form data.

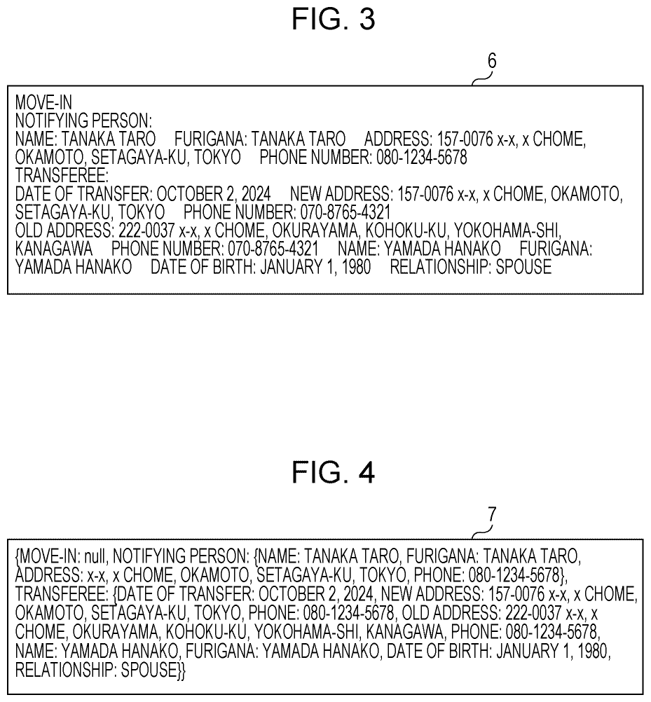

FIG. 3 is a diagram illustrating the entry example 6 generated by the generative AI 4, for the form 5 illustrated in FIG. 2. The generative AI 4 generates the entry example 6 in a text format. The entry example 6 is generated in a format of <item name: value> for each item of the form 5. An entry unit of <item name: value>is referred to as a “data element”.

In the form 5 illustrated in FIG. 2, for an item name “notifying person”, item names “address”, “furigana”, “name”, and “phone” are included. With this arrangement, entry fields are provided for the respective item names “address”, “furigana”, “name”, and “phone”. That is, a value of the item name “notifying person” includes data elements with the item names “address”, “furigana”, “name”, and “phone”. A data element that is not a value of another data element, such as “notifying person” in the form 5 illustrated in FIG. 2, is referred to as a “0th-order data element”.

A data element that is a value of “notifying person” serving as a parent item name such as “address” in the “notifying person” field is referred to as a “1st-order data element”. That is, the 1st-order data element is positioned as a child of the 0th-order data element. Similarly, when a value of the 1st-order data element is represented by another data element, the data element that is the value of the 1st-order data element is referred to as a “2nd-order data element”. That is, the 2nd-order data element is positioned as a grandchild of the 0th-order data element.

As described above, in some cases, the item to be filled in by the user in the form 5 is recursively composed of nth-order data elements (n is an integer of 0 or more). “n” is referred to as an order.

In the entry example 6, a line break is inserted after “item name:” for the item name of the 0th-order data element including the data elements of the 1st-order and subsequent data elements as its values. The values of the 0th-order data elements including the data elements of the 1st-order and subsequent data elements as its values are entered on the new line and subsequent lines.

The items “move-in”, “relocation”, and “move-out” of the form 5 illustrated in FIG. 2 are selection items for which a check mark is entered in rectangular check fields corresponding to the respective items. Among these selection items, only the selected item name is entered in the entry example 6. Therefore, the entry of “move-in” in a first row of FIG. 3 indicates that a check mark is entered in the item “move-in”.

The communication section 13 performs data communication with a server 3 connected to a communication line 2, such as the Internet. The generative AI 4 is stored in the server 3. Therefore, the communication section 13 transmits to the server 3 the form data read by the reading section 11 and the generation instruction of the entry example 6 generated by the instruction section 12. When receiving the form data and the generation instruction of the entry example 6, the server 3 inputs the form data to the generative AI 4 and transmits the entry example 6 output by the generative AI 4 to the information processing system 1 through the communication line 2. The communication section 13 receives the entry example 6 transmitted from the server 3 to the information processing system 1.

The processing section 14 processes a data format of the entry example 6 received by the communication section 13 from the server 3 into a data format convenient for specifying the entry areas to be filled in by the user from the form 5. As an example, the processing section 14 processes the data format of the entry example 6 into a JavaScript (registered trademark) Object Notation (JSON) format. In the JSON format, data elements are enclosed in curly brackets { } in order units, and a plurality of data elements are separated by “, (comma)”.

FIG. 4 is a diagram illustrating an example of processed data 7 processed by the processing section 14 based on the entry example 6 of the form 5 illustrated in FIG. 3.

For a selection item having no value, such as “move-in” in the entry example 6, the processing section 14 sets the value to null. Therefore, in the processed data 7 illustrated in FIG. 4, the data element of the selection item is processed as <move-in: null>. The value of the item name “notifying person” is represented by data elements “address”, “furigana”, “name”, and “phone”. Therefore, in the processed data 7 in FIG. 4, the data elements of the “notifying person” are processed as: <notifying person: {Name: Tanaka Taro, Furigana: Tanaka Taro, Address: 157-0076x-x, x chome, Okamoto, Setagaya-ku, Tokyo, Phone: 080-1234-5678}>.

For each data element of the processed data 7, the collation section 15 illustrated in FIG. 1 associates the item name of the data element with an item name contained in advance in the blank form data that does not include any information entered by the user. To associate an item name of a data element included in the processed data 7 with an item name contained in the blank form data indicates to search the blank form data for the same item name as the item name of the data element. On the other hand, display position information is associated with a character string of the form data. Therefore, when the same item name as the item name of the data element is obtained from the form data, the display position information of the item name of the data element in the form data is obtained. Therefore, the collation section 15 specifies an entry area around a location represented by the display position information of the retrieved item name as an entry area for the item name in the form 5.

In the blank form data, the combining section 16 embeds, for each data element of the processed data 7, the value of the data element in the entry area for entering a content of the item name specified by the collation section 15. That is, the combining section 16 generates completed form data by combining the blank form data with the entry example 6 generated by the generative AI 4.

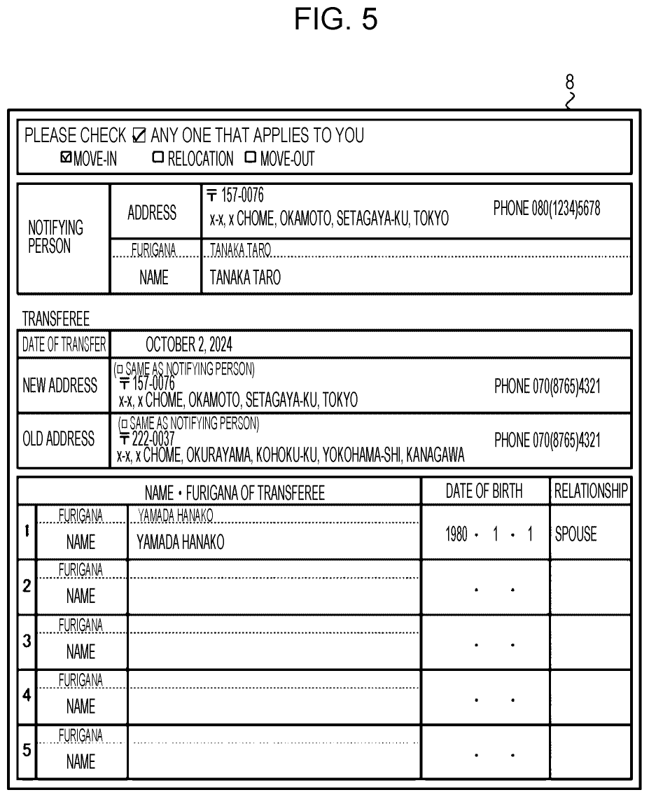

FIG. 5 is a diagram illustrating an example of a completed form 8 represented by the completed form data generated based on the processed data 7 illustrated in FIG. 4.

For the selection item having the value set to null, such as “move-in”, a check mark is entered in the corresponding check field. For example, in the entry areas of “address”, “furigana”, “name”, and “phone” in the “notifying person” field, the values of the corresponding data elements in the processed data 7 illustrated in FIG. 4 are entered.

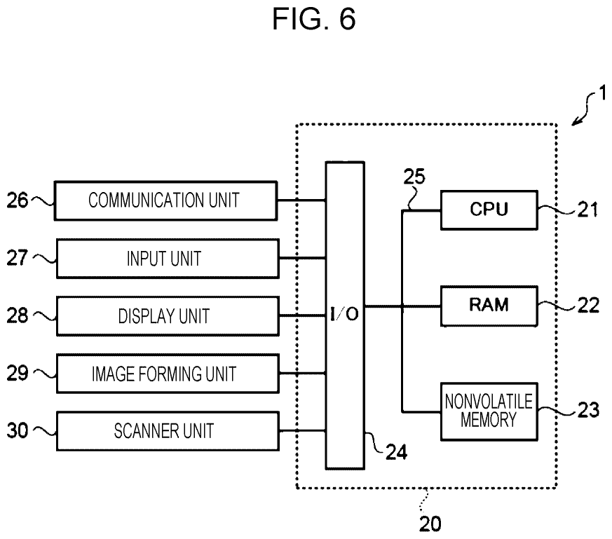

The output section 17 illustrated in FIG. 1 outputs the completed form 8 generated by the combining section 16. To output the completed form 8 indicates to make the completed form 8 available for the user to confirm. Therefore, a configuration in which the completed form 8 is displayed on a display unit 28 (FIG. 6) is an example of an output configuration of the completed form 8. A configuration in which the completed form 8 is transmitted to an external apparatus (not illustrated) via the communication line 2 is also an example of the output configuration of the completed form 8. A configuration in which the completed form 8 is printed on a recording medium such as a sheet is also an example of the output configuration of the completed form 8. A configuration in which the completed form 8 is stored in a storage apparatus (not illustrated) which the user is authorized to read is also an example of the output configuration of the completed form 8. As an example, the output section 17 according to the present exemplary embodiment displays the completed form 8 on the display unit 28.

Instead of deploying the generative AI 4 in the server 3, the generative AI 4 may be deployed in the information processing system 1.

The information processing system 1 having these functional sections is configured using a computer 20.

FIG. 6 is a diagram illustrating an exemplary configuration of main parts of an electrical system of the information processing system 1 configured using the computer 20.

The computer 20 configuring the information processing system 1 includes a central processing unit (CPU) 21, which is an example of a processor configured to execute functions. The computer 20 also includes a random access memory (RAM) 22 used as a temporary work area of the CPU 21, a nonvolatile memory 23, and an input/output interface (I/O) 24. The CPU 21, the RAM 22, the nonvolatile memory 23, and the I/O 24 are connected to each other via a bus 25.

The nonvolatile memory 23 is an example of a storage apparatus in which stored information is maintained even when power supplied to the nonvolatile memory 23 is cut off. While a semiconductor memory, for example, is used as the nonvolatile memory 23, a hard disk may be used instead. Information that needs to be continuously stored even when the power supply to the information processing system 1 is cut off, such as an information processing program that causes the computer 20 to function as the information processing system 1, is stored in the nonvolatile memory 23.

For example, a communication unit 26, an input unit 27, the display unit 28, an image forming unit 29, and a scanner unit 30 are connected to the I/O 24.

The communication unit 26 is connected to the communication line 2 and has a communication protocol for transmitting and receiving data to and from the server 3 and an external apparatus.

The input unit 27 is an apparatus that accepts an instruction from a user and notifies the CPU 21 of the instruction. The input unit 27 includes, for example, a button, a touch panel, a mouse, a keyboard, and a pointing device.

The display unit 28 is an example of a display apparatus that displays information processed by the CPU 21 as an image. The display unit 28 includes, for example, a liquid crystal display or an organic electroluminescence (EL) display.

The image forming unit 29 is a unit that forms accepted form data on a recording medium in accordance with an instruction from the CPU 21. The image forming unit 29 may use any image forming scheme, for example, any of an electrophotographic scheme, an inkjet scheme, and an offset printing scheme.

The scanner unit 30 is a unit that optically reads, for example, the content of the form 5 placed on a platen glass in accordance with an instruction from the CPU 21, and converts the read content of the form 5 into image data. The image data of the form 5 is converted into form data by the CPU 21. The information processing system 1 may accept the form data from an external apparatus through the communication unit 26.

As can be seen from the example of the configuration of the main parts of the electrical system of the information processing system 1 illustrated in FIG. 6, the information processing system 1 is implemented by, for example, an image forming apparatus using the computer 20.

Next, operations of the information processing system 1 will be described.

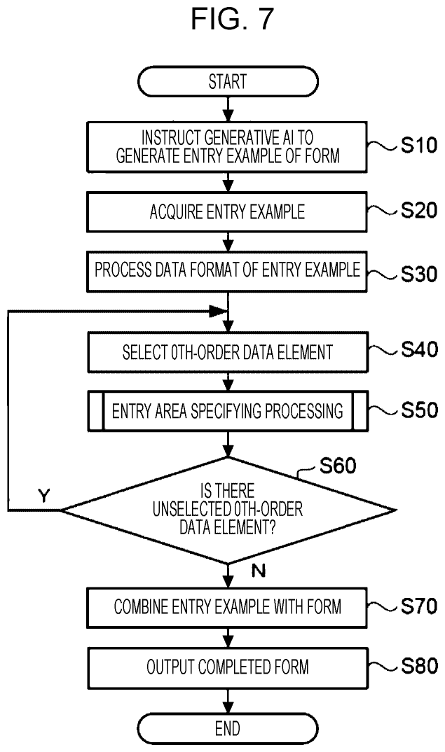

FIG. 7 is a flowchart illustrating an example of a flow of output processing of the entry example 6 executed by the CPU 21 of the information processing system 1 when blank form data that does not include any information entered by the user is accepted.

An information processing program that defines the output processing of the entry example 6 is stored in advance in, for example, the nonvolatile memory 23 of the information processing system 1. The CPU 21 of the information processing system 1 reads the information processing program stored in the nonvolatile memory 23 and executes the output processing of the entry example 6.

In step S10 of FIG. 7, the CPU 21 transmits the accepted form data to the generative AI 4 through the communication unit 26. Through the communication unit 26, the CPU 21 transmits to the generative AI 4 a generation instruction to generate the entry example 6 of the form 5. As the generation instruction, for example, an instruction “please create entry example of this form” is used.

Consequently, the generative AI 4 transmits the generated entry example 6 of the form 5 to the information processing system 1 through the communication line 2.

In step S20, the CPU 21 acquires the entry example 6 of the form 5 generated by the generative AI 4 through the communication unit 26.

In step S30, the CPU 21 performs processing of converting a data format of the entry example 6 of the form 5 generated by the generative AI 4 into a JSON format. As described above, the CPU 21 does not need to convert the entry example 6 of the form 5 into the JSON format. It is sufficient for the CPU 21 to convert the entry example 6 of the form 5 into a data format convenient for specifying an entry area to be filled in by the user from the form 5. When the generative AI 4 has generated the entry example 6 of the form 5 in advance in a data format, such as the JSON format, that is the same as the data format after conversion by the CPU 21, step S30 is unnecessary.

In step S40, the CPU 21 selects a 0th-order data element that has not yet been selected, from the processed data 7 of the entry example 6 of which data format has been processed in step S30. For convenience of description, the 0th-order data element selected in step S40 is referred to as a “selected data element”.

In step S50, the CPU 21 performs entry area specifying processing on the selected data element.

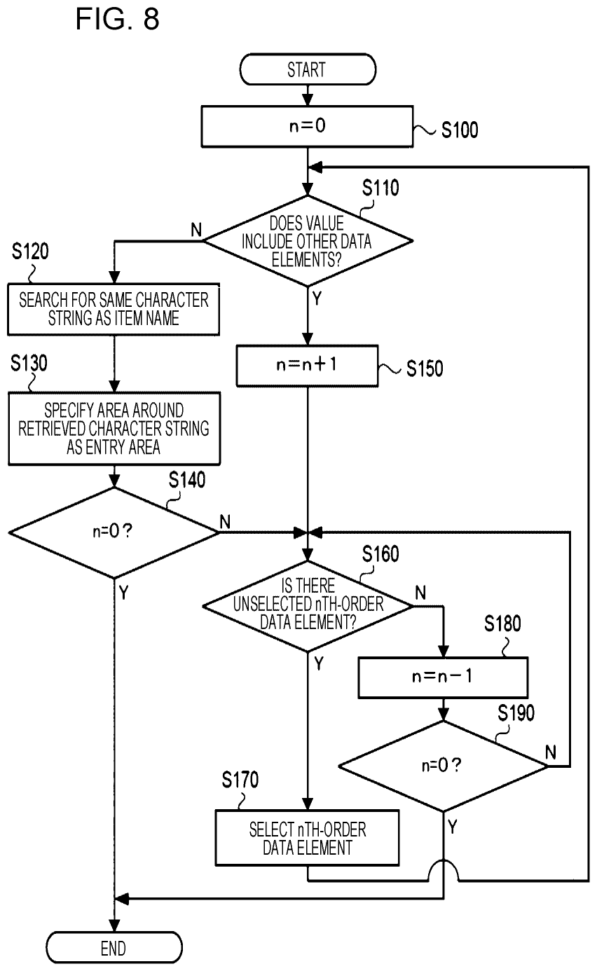

FIG. 8 is a flowchart illustrating an example of a flow of the entry area specifying processing for the selected data element.

In step S100 of FIG. 8, the CPU 21 sets an index n representing an order of a data element to “0”. This is because the order of the selected data element represents the 0th order.

In step S110, the CPU 21 determines whether a value of the data element to be processed (in this case, the selected data element) includes other data elements. When the value of the selected data element does not include other data elements, the processing proceeds to step S120.

In step S120, the CPU 21 searches the blank form data for the same item name as the item name of the selected data element.

In step S130, the CPU 21 acquires, from the form data, display position information associated with the item name in the blank form data retrieved in step S120. The CPU 21 specifies an area around a location in the form data represented by the display position information, as the entry area of the value for the item name of the selected data element.

Specifically, when the form 5 is written horizontally, the content for the item name is often entered on the right side of the item name in the same row as the item name. Therefore, when there is an entry field on the right side of the retrieved item name in the same row as the position of the retrieved item name, for example, the CPU 21 specifies the entry field as the entry area of the value for the item name of the selected data element. When there is no entry field on the right side of the retrieved item name in the same row as the position of the retrieved item name, the entry field is often provided on a lower area adjacent to the position of the retrieved item name. Therefore, for example, when there is no entry field on the right side of the retrieved item name in the same row as the position of the retrieved item name but there is an entry field on the lower side to be adjacent to the position of the retrieved item name, the CPU 21 may specify the entry field on the lower side as the entry area of the value for the item name of the selected data element.

When the selected data element is a selection item, a check field located at a position closest to the position of the retrieved item name may be specified as the entry area of the value for the item name of the selected data element. The check field for the selection item is often represented by a rectangle or a circle having substantially the same size as the characters of the character string representing the item name of the selection item. Therefore, it is sufficient for the CPU 21 to specify a rectangle or a circle having such characteristics as the entry area of the value for the item name of the selected data element. When the value of the selected data element is null, the CPU 21 determines that the selected data element is a selection item.

In step S140, the CPU 21 determines whether the index n is “0”. When the index n is “0”, it means that the entry areas of values for all the item names included in the selected data element have been specified. Therefore, the CPU 21 ends the entry area specifying processing illustrated in FIG. 8, and proceeds to step S60 in FIG. 7.

In the processed data 7 illustrated in FIG. 4, <move-in: null> is an example of the 0th-order data element. Therefore, for the data element of <move-in: null>, an entry area of a value for “move-in” is specified by the above-described processing.

On the other hand, the data element <notifying person: {Name: Tanaka Taro, Furigana: Tanaka Taro, Address: 157-0076 x-x, x chome, Okamoto, Setagaya-ku, Tokyo, Phone: 080-1234-5678}> of the processed data 7 illustrated in FIG. 4 includes other data elements as values. Assume that such a data element is selected as the selected data element in step S40 of FIG. 7. In this case, with the determination processing in step S110 in FIG. 8, it is determined that the value of the selected data element includes other data elements, and the processing proceeds to step S150.

For convenience of description, the data element of <notifying person: {Name: Tanaka Taro, Furigana: Tanaka Taro, Address: 157-0076 x-x, x chome, Okamoto, Setagaya-ku, Tokyo, Phone: 080-1234-5678}> is referred to as a “notifying person data element”.

In step S150, the CPU 21 adds “1” to the index n. Since other data elements are included in the value of the nth-order data element, the other data elements included in the value are processed as data elements of an order obtained by adding “1” to the index n.

In step S160, the CPU 21 determines whether there is an unselected nth-order data element. When there is an unselected nth-order data element, the processing proceeds to step S170.

In step S170, the CPU 21 selects one nth-order data element to be newly processed from among the unselected nth-order data elements, and the processing proceeds to step S110.

As described above, in step S110, it is determined whether the value of the data element to be processed (in this case, the nth-order data element) includes other data elements. For example, with regard to <Name: Tanaka Taro> which is an example of a 1st-order data element in the notifying person data element, the value thereof does not include other data elements. Therefore, in steps S120 and S130, the entry area of the name of the notifying person is specified.

When the index n is 1 or more, i.e., indicates an nth-order data element, the processing proceeds to step S160 as a result of the determination processing in step S140. Therefore, as long as there is an unselected nth-order data element of the same order (where n is 1 or more), the nth-order data element of the same order is selected in step S170. When the value of the selected nth-order data element does not include other data elements, as described above, the entry area of the nth-order data element is specified in steps S120 and S130.

When it is determined by the determination processing in step S160 that there is no unselected nth-order data element having the same order, the processing proceeds to step S180.

Since there is no unselected nth-order data element having the same order, the CPU 21 returns the processing target to an nth-order data element serving as a parent when viewed from the nth-order data element. That is, the CPU 21 returns the entry area specifying processing to be recursively processed to an immediately higher processing unit (also referred to as a “nest”).

Therefore, in step S180, the CPU 21 subtracts “1” from the index n.

In step S190, the CPU 21 determines whether the index n is “0”. When the index n is not “0”, the CPU 21 continues to specify the entry area for the nth-order data element in the immediately higher processing unit in which the recursive processing is to be performed during the processing. Therefore, the processing proceeds to step S160, and the CPU 21 determines whether there is an unselected nth-order data element in the immediately higher processing unit.

When it is determined in the determination processing of step S190 that the index n is “0”, it means that the specification of the entry area for the selected data element has been completed. Therefore, the entry area specifying processing illustrated in FIG. 8 ends, and the processing proceeds to step S60 in FIG. 7.

After the processing above, the entry area of the value for the item name of the selected data element is specified. The CPU 21 stores the specified entry area in association with each of the data elements in, for example, the nonvolatile memory 23.

In step S60 of FIG. 7, the CPU 21 determines whether there is an unselected 0th-order data element in the processed data 7 of the entry example 6. When there is an unselected 0th-order data element, the processing proceeds to step S40. In step S40, the CPU 21 selects the unselected 0th-order data element from the processed data 7 of the entry example 6 as a new selected data element. Until it is determined that there is no unselected 0th-order data element by the determination processing in step S60, the CPU 21 performs the entry area specifying processing on the new selected data element.

When it is determined that there is no unselected 0th-order data element by the determination processing in step S60, the processing proceeds to step S70.

In step S70, for each item in the form 5, the CPU 21 embeds the value of the data element having the same item name in the entry area associated with the data element. Consequently, the completed form 8 in which the entry example 6 generated by the generative AI 4 is combined with the blank form data as illustrated in FIG. 5 is obtained.

In step S80, the CPU 21 displays, on the display unit 28, the completed form 8 containing the entry example 6 generated by the generative AI 4. After the processing above, the output processing of the entry example 6 illustrated in FIG. 7 ends.

The generative AI 4 learns a correspondence relationship between various types of forms 5 and an entry content in each item of the form 5 through learning data. Therefore, with regard to an unknown form 5, the generative AI 4 generates the entry example 6 based on the learned correspondence relationship. Consequently, even when the form 5 accepted from the user is the unknown form 5, the information processing system 1 specifies an entry area corresponding to each item of the form 5.

In the output processing of the entry example 6 illustrated in FIG. 7, the completed form 8 containing the entry example 6 is displayed on the display unit 28. However, the CPU 21 may indicate an entry area to be filled in by the user in the form 5. In this case, the CPU 21 indicates a range of the entry area in the form 5 specified based on the entry example 6 by using a graphic, such as a rectangle or an arrow.

The CPU 21 may use the image forming unit 29 to print the completed form 8 on a recording medium.

With the output processing of the entry example 6 illustrated in FIG. 7, the entry example 6 is combined with the blank form data to generate the completed form 8. However, the CPU 21 may generate the completed form 8 by using another method.

For example, the CPU 21 may combine the entry example 6 with image data of the form 5 obtained by the scanner unit 30. In this case, the CPU 21 performs optical character recognition (OCR) processing on the image data of the form 5. The OCR processing is processing of performing character recognition based on shapes of characters displayed in an image and converting the image into character data. With the OCR processing, display position information of the recognized characters is also obtained. In step S50 of FIG. 7, the CPU 21 may search the character data of the form 5 for the same item name as the item name of the selected data element instead of the form data. The CPU 21 acquires, from the OCR result, display position information associated with the retrieved item name included in the character data. The CPU 21 specifies an area around the location in the image data of the form 5 represented by the display position information as the entry area of the value for the item name of the selected data element. Note that the entry example 6 is character data. Therefore, when the value of the data element in the entry example 6 is to be embedded in the specified entry area in the image data of the form 5, the CPU 21 converts the value of the data element from character data into image data and combines the pieces of image data.

With reference to the search result obtained by respectively searching the form data of the form 5 and the image data of the form 5 for the same item name as the item name of the selected data element, the CPU 21 may specify the entry area of the value for the item name of the selected data element. Depending on the situation, the entry areas specified from the form data of the form 5 and the image data of the form 5 may be different. In this case, the CPU 21 sets one of the entry areas as the entry area of the value for the item name of the selected data element. With this arrangement, for example, the CPU 21 may display, on the form 5, a warning that there may be an error in the entry area.

Furthermore, the CPU 21 may input, to a different generative AI (not illustrated) from the generative AI 4, an instruction to request to embed the entry example 6 generated by the generative AI 4 in the corresponding entry area of the blank form data together with the form data. Upon accepting the instruction, the different generative AI generates form data in which the value of each data element in the entry example 6 is embedded in the corresponding entry area. Therefore, the CPU 21 displays the form data generated by the different generative AI on the display unit 28 as the completed form 8. When the generative AI 4 has a function of the different generative AI, the CPU 21 may instruct the generative AI 4 to embed the entry example 6 in the corresponding entry area of the blank form data.

### Replacement Display of User Information

With the output processing of the entry example 6 illustrated in FIG. 7, the content of the entry example 6 generated by the generative AI 4 is entered in the form 5. The entry example 6 is merely an example of the entry content to be entered in the form 5. Therefore, with reference to the completed form 8 containing the entry example 6, the user enters his/her information in the form 5.

In order to reduce the time and effort required for the user to enter the information in the form 5, the information processing system 1 generates the completed form 8 containing the user information.

Therefore, the CPU 21 may replace the entry content of the completed form 8 created based on the entry example 6 with the information on the user. The information on the user who enters the information in the blank form data is referred to as “user information 9”.

Thus, the CPU 21 acquires the user information 9 together with the blank form data. To be specific, the CPU 21 acquires the user information 9 from a reference form containing the user information 9 or a storage apparatus storing the user information 9.

Examples of the reference form containing the user information 9 include documents such as a user's certificate of residence, a driver's license, a passport, and a health insurance card. Examples of the reference form containing the user information 9 include documents such as a receipt, a postcard, and a letter. Examples of the storage apparatus storing the user information 9 include an IC card. Further, for example, registration information of the user registered in a web service is also an example of the user information 9 stored in the storage apparatus.

Through the communication unit 26, the scanner unit 30, and a card reader (not illustrated) connected to the I/O 24, the CPU 21 acquires the user information 9 from the reference form containing the user information 9 or the storage apparatus storing the user information 9.

For example, the scanner unit 30 is used to acquire the user information 9 from a document. The CPU 21 performs OCR processing on the image data of the document acquired through the scanner unit 30 and acquires the user information 9 entered in the document. The card reader is used to acquire the user information 9 from the IC card. The communication unit 26 is used to acquire the user information 9 from the web service. The CPU 21 may acquire the user information 9 input by the user through the input unit 27.

The CPU 21 displays a selection screen (not illustrated) for prompting the user to select an acquisition source of the user information 9 on the display unit 28 and prompts the user to select the acquisition source of the user information 9. As the acquisition sources of the user information 9, for example, a document, an IC card, a web service, and an input by the user are displayed on the selection screen. The CPU 21 acquires the user information 9 from the selected acquisition source.

After step S70 in FIG. 7 ends, the CPU 21 searches the acquired user information 9 for the same item name as the item name of the form data containing the entry example 6. When there is the same item name, the CPU 21 replaces the entry content entered based on the entry example 6 in the entry area corresponding to the item name in the form data with the entry content corresponding to the same item name in the user information 9.

With the use of the different generative AI, the CPU 21 may acquire the user information 9 to be used for replacing the entry content of the completed form 8 created based on the entry example 6. For example, the CPU 21 inputs image data of a document containing the user information 9 to the different generative AI. The CPU 21 then inputs, to the different generative AI, an instruction to request to extract the user information 9 from the input document. In this case, the item names of the form data in which the entry contents of the entry example 6 are entered are known in advance. Therefore, the CPU 21 preferably requests the different generative AI to extract the user information 9 corresponding to the item names from the document. Consequently, the user information 9 used to replace the entry content of the completed form 8 created based on the entry example 6 is obtained from the document.

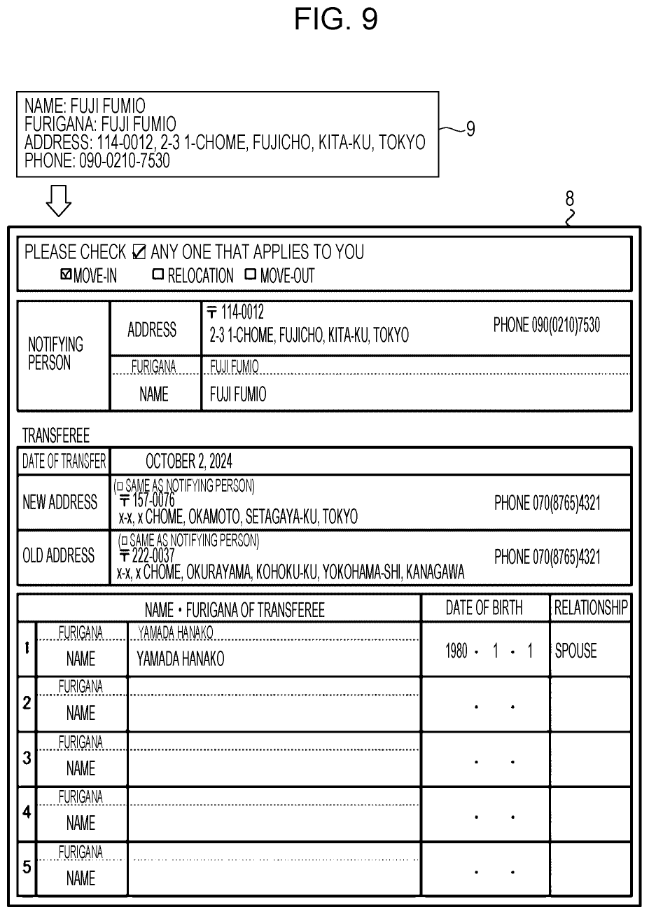

FIG. 9 is a diagram illustrating an example of the completed form 8 in which the entry example 6 of the form data has been replaced with the user information 9. The completed form 8 illustrated in FIG. 9 is an example of a replaced form obtained by replacing the entry content of the completed form 8 containing the entry example 6 illustrated in FIG. 5 with the entry content of the user information 9 illustrated in FIG. 9.

FIG. 9 illustrates the completed form 8 obtained by replacing the entry contents of the address, furigana, name, and phone of the notifying person in the completed form 8 illustrated in FIG. 5 with information included in the user information 9 illustrated in FIG. 9.

In step S80 in FIG. 7, the CPU 21 displays, on the display unit 28, the completed form 8 of which the entry contents have been replaced with the user information 9. The completed form 8 in which the entry contents created based on the entry example 6 have been replaced with the user information 9 is an example of the replaced form.

Some of the item names of the completed form 8 created based on the entry example 6 are not included in the user information 9. The entry contents corresponding to these item names are not replaced with the user information 9, and the entry contents indicated in the entry example 6 remain.

For example, the user information 9 illustrated in FIG. 9 does not include information about a “new address” of the user. Therefore, in the completed form 8 illustrated in FIG. 9, the entry content in the entry field corresponding to the item name “new address” is not replaced with the user information 9, and the entry contents in the entry example 6 illustrated in FIG. 3 are embedded as they are.

When only a part of the completed form 8 is replaced with the user information 9 in this manner, the user may view only the part replaced with the user information 9 and misunderstand that all the entry contents have been replaced with the user information 9.

Therefore, the CPU 21 compares the item names for which the entry contents based on the entry example 6 are entered in the completed form 8 created based on the entry example 6 with the item names included in the acquired user information 9. When the acquired user information 9 does not include all the item names for which the entry contents based on the entry example 6 are entered in the completed form 8, the CPU 21 outputs a warning to the user. Furthermore, among the item names for which the entry contents based on the entry example 6 of the completed form 8 are entered, the CPU 21 may display, on the display unit 28, the item names that are not included in the user information 9.

When the acquired user information 9 does not include all the item names displayed in the completed form 8, the CPU 21 may output a warning to the user. In this case, the CPU 21 displays, on the display unit 28, the item names that are not included in the user information 9 among the item names displayed in the completed form 8.

### Correction of Entry Content by User

The generative AI 4 outputs, for the form 5, a character string representing an item name to be filled in by the user and an entry content in the entry area. However, an entry content of another item name is not corrected according to an entry content of a specific item name. This will be discussed with reference to the completed form 8 illustrated in FIG. 5, which is created based on the entry example 6 generated by the generative AI 4 illustrated in FIG. 3.

In the completed form 8 illustrated in FIG. 5, a name of a notifying person is “Tanaka Taro”, and a name of a transferee is “Yamada Hanako”. A relationship of the transferee to the notifying person is “spouse”. When the relationship is spouse, the entry example 6 in which the surnames of the names of notifying person and transferee are the same is preferable for easy understanding.

Since the generative AI 4 does not evaluate a validity of the entry content, a future date may be output as a value of a date of birth, for example. The generative AI 4 may also present the entry example 6 for an item that the user does not need to enter.

When embedding the entry example 6 in the blank form data in step S70 illustrated in FIG. 7, the CPU 21 may embed the entry example 6 in a wrong entry field. For example, with regard to the item name “name” in the form 5 illustrated in FIG. 2, there are a plurality of same item names, such as the “name” of a notifying person and the “name” of a transferee. Therefore, when the CPU 21 searches for an item name of the blank form data that matches “name” in the entry example 6, the “name” of the notifying person and the “name” of the transferee are retrieved. In this case, the CPU 21 may embed the same name in the entry field for the name of the notifying person and the entry field for the name of the transferee.

Therefore, the information processing system 1 accepts a correction from the user to the completed form 8 in which the entry contents have been entered based on the entry example 6.

To be specific, the CPU 21 accepts a correction instruction from the user through the input unit 27. The correction instruction includes at least one of a correction of an entry content entered in the completed form 8, a change of an entry position, a change of a character size used to enter the entry content, and a deletion of the entry content.

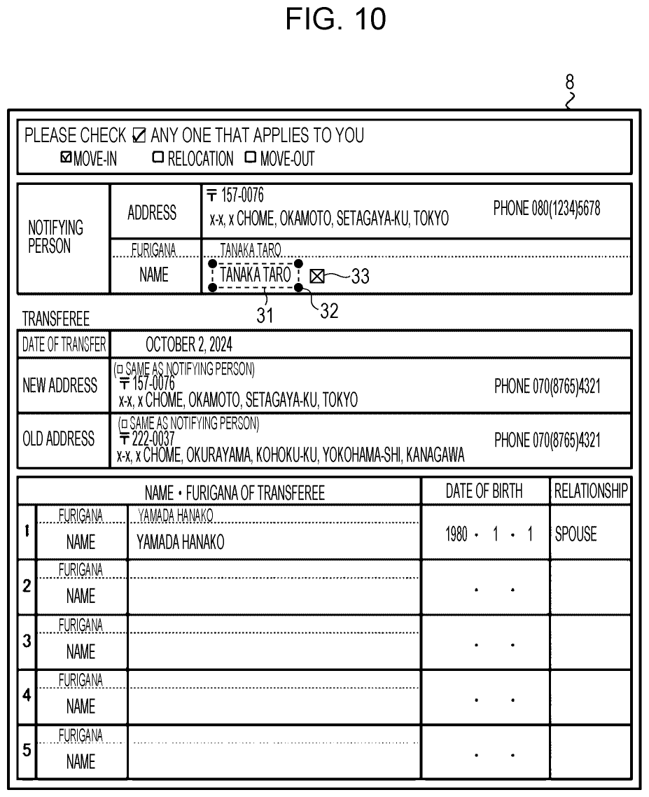

FIG. 10 is a diagram illustrating a display example of the completed form 8 for which a correction instruction is accepted from the user. When the correction instruction is accepted from the user, the CPU 21 sets the completed form 8 to an edit mode. In the edit mode, the user can edit the completed form 8 displayed on the display unit 28 by performing an operation using a mouse or the like.

For example, when an instruction to correct the name of the notifying person is accepted, the CPU 21 displays a box 31 enclosing the name and a deletion item 33. There is an editing point 32 at each vertex of the box 31. The instruction to correct the name of the notifying person is issued by, for example, selecting an entry field for the name of the notifying person with a mouse or the like.

When the user selects and moves an area of the box 31 other than the editing points 32 with a mouse or the like, the CPU 21 moves the name enclosed in the box 31 together with the box 31. Consequently, the entry position of the name is changed.

When the user selects and moves any one of the editing points 32 with a mouse or the like, the CPU 21 enlarges or reduces the size of the box 31 in accordance with the direction of movement of the editing point 32. Consequently, the character size of the name enclosed in the box 31 is enlarged or reduced.

When the user selects an area in the box 31 with a mouse or the like, the CPU 21 accepts editing of the characters enclosed in the box 31. Consequently, the entry content entered in the completed form 8 is corrected.

When the user selects the deletion item 33 with a mouse or the like, the CPU 21 deletes the characters enclosed in the box 31. Consequently, the entry content in the selected entry field is deleted.

Not only in the completed form 8 in which the entry contents have been entered based on the entry example 6 but also in the completed form 8 in which the entry example 6 of the form data has been replaced with the user information 9, the CPU 21 makes a correction in accordance with a correction instruction from the user.

While one aspect of the information processing system 1 has been described above with reference to the exemplary embodiment, the disclosed configuration of the information processing system 1 is merely an example. The configuration of the information processing system 1 is not limited to the scope described in the exemplary embodiment. Various modifications or improvements may be made to the exemplary embodiment without departing from the spirit of the present disclosure. Configurations to which the above modifications or improvements are added are also included in the technical scope of the disclosure. For example, without departing from the spirit of the present disclosure, the internal processing order of the output processing of the entry example 6 illustrated in FIG. 7 and the entry area specifying processing illustrated in FIG. 8 may be changed.

In the above exemplary embodiment, the configuration in which the output processing of the entry example 6 is implemented by software has been described as an example. However, equivalent processing to that illustrated in the flowcharts may be executed by hardware. In this case, a processing speed is increased compared to the case where the output processing of the entry example 6 is implemented by software.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a CPU, a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. The program according to the present disclosure may be provided as a program product.

Furthermore, the information processing system 1 may download the information processing program from an external apparatus via the communication unit 26 and store the downloaded information processing program in the nonvolatile memory 23.

### APPENDIX

### (((1)))

An information processing system comprising:
a processor configured to:
acquire, by inputting form data to a language model, an entry area to be filled in by a user in the form data input to the language model from the language model, the form data being blank form data having no entry in the entry area; and
specify the entry area in the form data input to the language model.

### (((2)))

The information processing system according to (((1))), wherein
the language model represents the entry area in the blank form data by a character string representing an item name of an entry area filled in by a user and an entry content in the entry area, and
the processor is configured to associate the item name included in the character string with an item name contained in advance in the blank form data to specify the entry area in the form data input to the language model.

### (((3)))

The information processing system according to (((2))), wherein
the processor is configured to display a completed form in which each entry content associated with the item name included in the character string used to specify the entry area in the blank form data is entered in the corresponding entry area in the blank form data.

### (((4)))

The information processing system according to (((3))), wherein
the processor is configured to display a replaced form in which the entry content serving as an entry example of the blank form data and displayed in the corresponding entry area of the completed form is replaced with user information that is information related to the user who enters information in the blank form data.

### (((5)))

The information processing system according to (((4))), wherein
the processor is configured to acquire the user information from a reference form containing the user information or a storage apparatus storing the user information.

### (((6)))

The information processing system according to (((4))) or (((5))), wherein
the processor is configured to output a warning when the acquired user information does not include all item names contained in the form data.

### (((7)))

The information processing system according to any one of (((4))) to (((6))), wherein
the processor is configured to display an item name of an entry area in the blank form data that is not included in the user information.

### (((8)))

The information processing system according to any one of (((3))) to (((7))), wherein
the processor is configured to accept a correction to the completed form from the user.

### (((9)))

The information processing system according to (((8))), wherein
the processor is configured to accept, from the user, at least one of a correction of the entry content entered in the completed form, a change of an entry position, a change of a character size used to enter the entry content, or a deletion of the entry content.

### (((10)))

A program causing a computer to execute a process for information processing, the process comprising:
acquiring, by inputting form data to a language model, an entry area to be filled in by a user in the form data input to the language model from the language model, the form data being blank form data having no entry in the entry area; and
specifying the entry area in the form data input to the language model.

What is claimed is:

1. An information processing system comprising:
a processor configured to:
acquire, by inputting form data to a language model, an entry area to be filled in by a user in the form data input to the language model from the language model, the form data being blank form data having no entry in the entry area; and
specify the entry area in the form data input to the language model.

2. The information processing system according to claim 1, wherein
the language model represents the entry area in the blank form data by a character string representing an item name of an entry area filled in by a user and an entry content in the entry area, and
the processor is configured to associate the item name included in the character string with an item name contained in advance in the blank form data to specify the entry area in the form data input to the language model.

3. The information processing system according to claim 2, wherein
the processor is configured to display a completed form in which each entry content associated with the item name included in the character string used to specify the entry area in the blank form data is entered in the corresponding entry area in the blank form data.

4. The information processing system according to claim 3, wherein
the processor is configured to display a replaced form in which the entry content serving as an entry example of the blank form data and displayed in the corresponding entry area of the completed form is replaced with user information that is information related to the user who enters information in the blank form data.

5. The information processing system according to claim 4, wherein
the processor is configured to acquire the user information from a reference form containing the user information or a storage apparatus storing the user information.

6. The information processing system according to claim 5, wherein
the processor is configured to output a warning when the acquired user information does not include all item names contained in the form data.

7. The information processing system according to claim 6, wherein
the processor is configured to display an item name of an entry area in the blank form data that is not included in the user information.

8. The information processing system according to claim 4, wherein
the processor is configured to accept a correction to the replaced form from the user.

9. The information processing system according to claim 5, wherein
the processor is configured to accept a correction to the replaced form from the user.

10. The information processing system according to claim 6, wherein
the processor is configured to accept a correction to the replaced form from the user.

11. The information processing system according to claim 7, wherein
the processor is configured to accept a correction to the replaced form from the user.

12. The information processing system according to claim 8, wherein
the processor is configured to accept, from the user, at least one of a correction of the entry content entered in the completed form, a change of an entry position, a change of a character size used to enter the entry content, or a deletion of the entry content.

13. The information processing system according to claim 9, wherein
the processor is configured to accept, from the user, at least one of a correction of the entry content entered in the completed form, a change of an entry position, a change of a character size used to enter the entry content, or a deletion of the entry content.

14. The information processing system according to claim 10, wherein
the processor is configured to accept, from the user, at least one of a correction of the entry content entered in the completed form, a change of an entry position, a change of a character size used to enter the entry content, or a deletion of the entry content.

15. The information processing system according to claim 11, wherein
the processor is configured to accept, from the user, at least one of a correction of the entry content entered in the completed form, a change of an entry position, a change of a character size used to enter the entry content, or a deletion of the entry content.

16. A non-transitory computer readable medium storing a program causing a computer to execute a process for information processing, the process comprising:
acquiring, by inputting form data to a language model, an entry area to be filled in by a user in the form data input to the language model from the language model, the form data being blank form data having no entry in the entry area; and
specifying the entry area in the form data input to the language model.
